(19) United States
(12) Patent Application Publication
(10) Pub. No.: US 2009/0125533 A1
(43) Pub. Date: May 14, 2009

(54) Reference-Based Technique for Maintaining Links

(76) Inventor: Mercelo A. Calbucci, Redmond, WA (US)

Correspondence Address: John Whitaker;Whitaker Law Group, 755 WINSLOW WAY EAST, Suite 100, BAINBRIDGE ISLAND, WA, 98110, US

(21) Appl. No.: 12/177,086

(22) Filed: Jul. 21, 2008

Related U.S. Application Data
(60) Provisional application No. 60/961,060, filed on Jul. 19, 2007.

(51) Int. Cl. G06F 17/00; G06F 17/30

(52) U.S. Cl. 707/100; 715/208

(57) ABSTRACT

Described herein, among other things, are implementations for a reference-based link module. The reference-based link module is configured to input a Web document having one or more links and convert the links to a reference-based link in a modified Web document. Mappings from the links to the corresponding reference-based links are stored and then accessed when the web document is requested.

### REFERENCE TO RELATED APPLICATIONS

This application claims priority to co-pending U.S. Provisional Patent Application No. 60/961,060 entitled System and Method to Adjust URLs if Content is Moved or Renamed Inside a Website, filed on Jul. 19, 2007, which is hereby incorporated by reference for all purposes.

### BACKGROUND

With the explosion of content available over the Internet, the problem of maintaining countless individual web pages and resources is becoming increasingly burdensome. For instance, individuals maintain personal websites, businesses maintain corporate and marketing websites, online vendors maintain various e-commerce websites. However, locations of individual web pages and names of web pages may change over time. When that happens, URLs (Uniform Resource Locators) on existing pages that pointed to the moved or deleted pages no longer work. These obsolete links are referred to as “dead links”, “broken links”, or “dangling links”. For the purpose of this document, the term “dead link” will be used to collectively refer to any obsolete link that no longer points to an actual resource on the web.

When dead links happens, a user trying to visit a web page using a dead link will receive the infamous “404” error. Dead links are annoying to most users and are disruptive to the users' experience. In addition, dead links make the website appear unprofessional. One technique for minimizing dead links is to employ a link checking tool. The link checking tool tests the validity of the links on each of the web pages of a website. The link checking tool may then provide a listing of the dead links so that the link can be manually corrected. Unfortunately, as websites become quite large or if one service maintains multiple websites, the task of manually fixing dead links becomes daunting.

### SUMMARY

Described herein, among other things, are implementations for a reference-based link system and methods for maintaining and managing links on a website. The reference-based link system is configured to evaluate a Web document having one or more links and convert the links to a reference-based link in a modified Web document. Mappings from the links to the corresponding reference-based links are stored and then accessed when the web document is requested.

### BRIEF DESCRIPTION OF THE DRAWINGS

Many of the attendant advantages of the present reference-based link system will become more readily appreciated as the same becomes better understood with reference to the following detailed description. A description of each drawing is briefly described here.

FIG. 1 is a functional block diagram generally illustrating a network computing environment in which is implemented a reference-based link system.

FIG. 2 are examples of links and corresponding reference-based links generated by a reference-based link module in the reference-based link system of FIG. 1.

FIG. 3 is an example of a mapping table created by the reference-based link module during processing of a web document.

FIG. 4 is an example of a history table that is generated by the reference-based link module.

FIG. 5 is a flow diagram illustrating a process for converting links in web documents to reference-based links.

FIG. 6 is a flow diagram illustrating a process for converting reference-based links to conventional links.

FIG. 7 is a functional block diagram of an exemplary computing device that may be used to implement one or more embodiments of the reference-based link system shown in FIG. 1.

Embodiments of the present reference-based link system and technique will now be described in detail with reference to these Figures in which like numerals refer to like elements throughout.

### DETAILED DESCRIPTION

Briefly stated, a reference-based link system is described that may be implemented to maintain a web site. The reference-based link system seeks to overcome the problems described above by introducing a pointer-like code to identify each resource under the website's control. The code does not change regardless of any changes to the resources name or location. The reference-based link system replaces links embedded in each file associated with a web site with reference-based links. The reference-based link system allows a user to edit files without being aware of how the links are maintained. Instead, the user views and edits the links using the conventional format. The reference-based link system auto-fixes links as destinations of the links are changed and fixes old incoming links using a history file. The system performs these tasks transparently to the user. Particular embodiments and implementations of this general concept will now be described in detail.

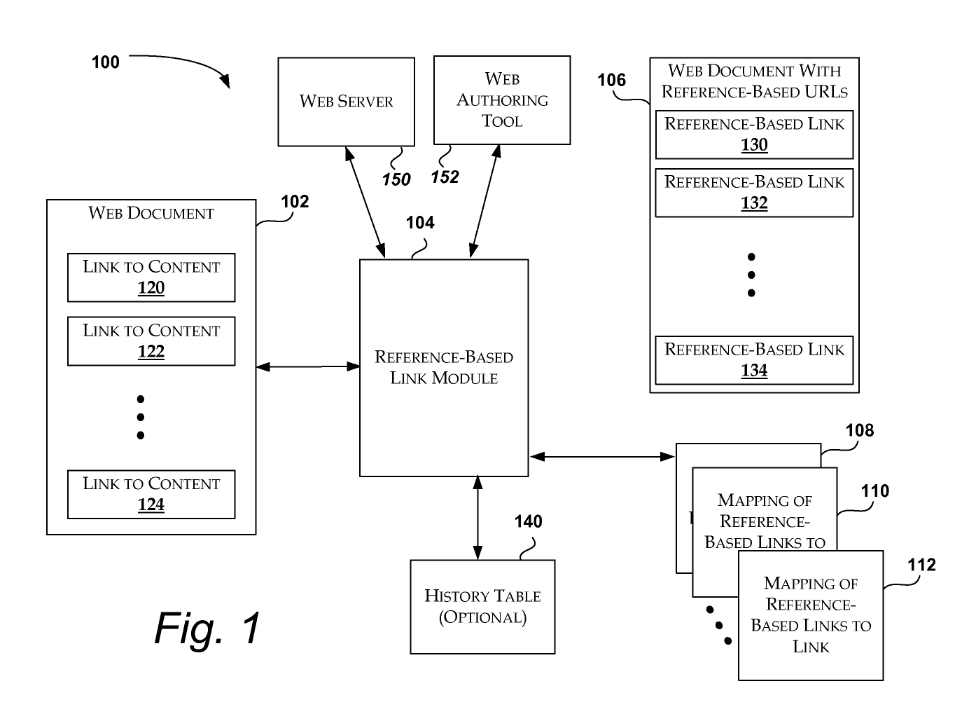

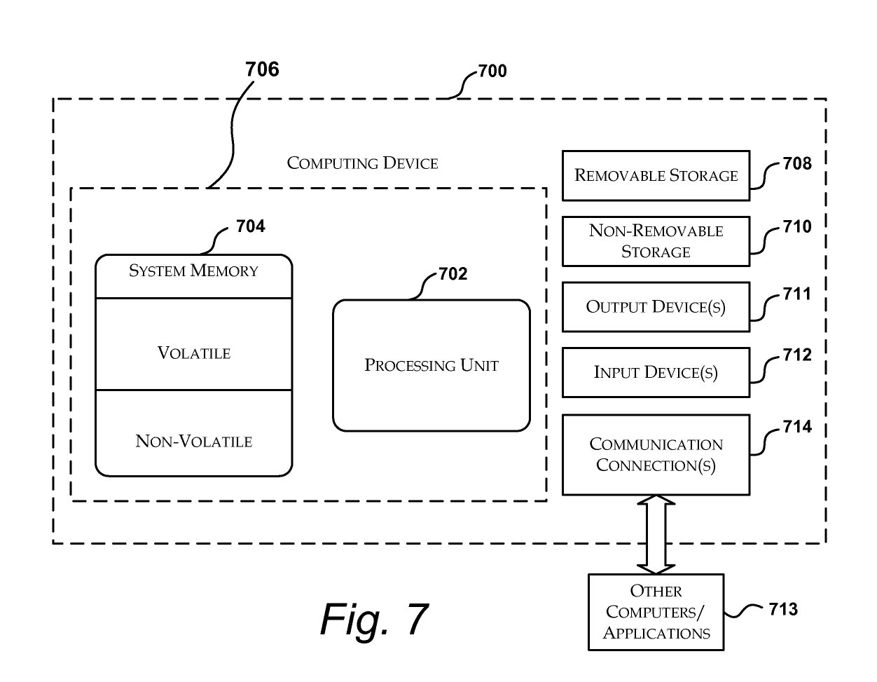

FIG. 1 is a functional block diagram generally illustrating a computing environment in which is implemented a reference-based link system 100. The reference-based link system includes a web document 102, a reference-based link module 104, a modified web document 106, and one or more maps 108-112. The reference-based link module 104 may be implemented in various ways. For example, the module 104 may be implemented as a stand alone software module that is initiated upon user request or upon some other trigger. The module 104 could be implemented as a plug-in to a web-authoring service 152 whereby module 104 executes upon a specific event, such as a file save operation. Thus, whenever a file is created, modified, or deleted on a website, the reference-based link module executes to update the corresponding reference-based links and mappings. In another implementation, the module 104 may be invoked whenever a web server 150 attempts to access a file maintained on the web site. In one embodiment, portions of the module may be installed as a plug-in module within web server 150. Web server 150 is a computing device as illustrated in FIG. 7 and described below.

Web document 102 includes any type of file having one or more links, such as links 120-124. Web document 102 may be written using a mark-up language, such as hyper-text mark-up language (HTML) or the like. Links 120-124 point to content of various forms, such as web page, image, audio file, video file, blog entry, and the like. Thus, for the purpose of this application, a web document may refer to a file containing multiple links or refer to a single link, such as a URL. The content associated with links 120-124 are displayed when the corresponding content is rendered by a browser.

Reference-based link module 104 inputs web document 102 and outputs modified web document 106. For each link 120-124 in web document 102, module 104 creates a reference-based link 130-134 within modified web document 106. Module 104 also creates one or more maps 108-112. Maps 108-112 correlate links 120-124 to reference-based links 130-134. The reference-based link module 104 executes on one or more computing devices such as computing device illustrated in FIG. 7 and described below. Typically, the reference-based link module 104 will execute on a computing device connected to the Internet.

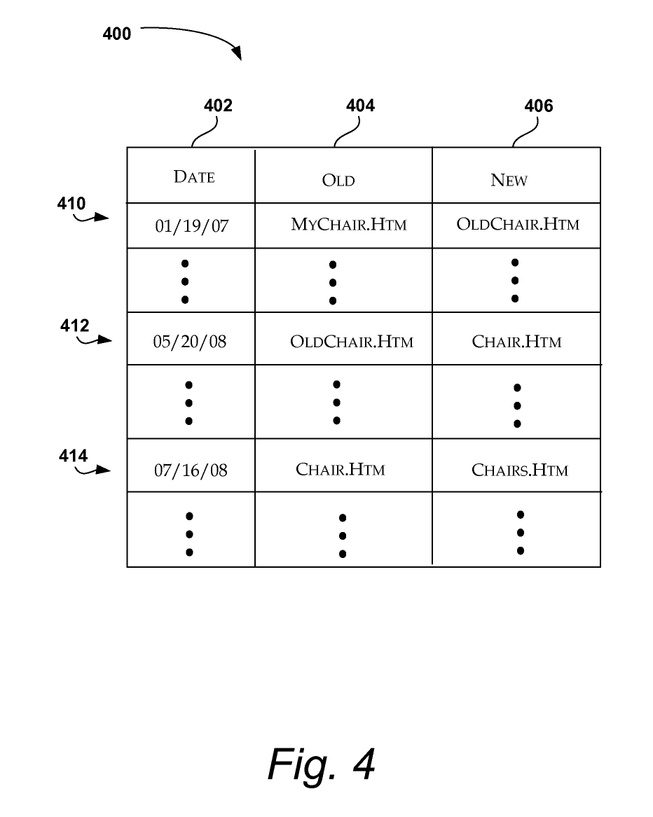

Reference-based link system 100 may also include an optional history table 140. History table 140 contains changes made to links 120-124. For example, if link 120 changed from chair.htm to chairs.htm, history table 140 would include both the old string and the new string along with a time stamp. One exemplary format for a history table is illustrated in FIG. 4 and described below. Because the reference-based link module oversees changes to files within the web site, the module is aware when one of the names of the file are changed. The information in the history table 140 is used when a specific link is requested but a file with that name is not currently on the website. When this happens, the reference-based link module, searches through the history table to identify the requested file.

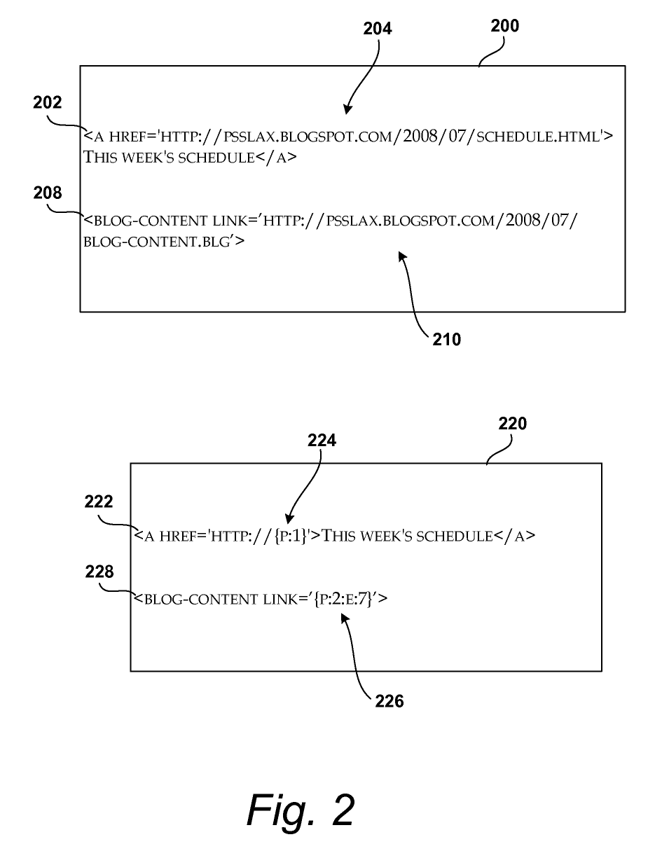

FIG. 2 are examples 200 of links and corresponding reference-based links 220 generated by the reference-based link module. Link 202 identifies a URL 204. The URL 204 identifies a domain (“psslax.blogspot.com”), a path (“/2008/07”), and a specific resource (“schedule.html”). In this case, the resource is identified as a markup language page, but could equally be any type of resource. Reference-based link 222 corresponds to link 202. A code 224 replaces URL 204. For mark-up languages, the code 224 may include a special symbol to indicate that the start of a reference-based link. In the example shown, the special symbol is a bracket “{”. However, any special symbol can be used. It is desirable to use a special symbol that is not common in the mark-up language being used. Code 224 also includes a table indicator “P:” and an id within the table “1”.

Link 208 identifies a blog entry 210 that makes sense to a blog rendering engine and includes a URL which identifies a blog entry for the blog rendering engine. Reference-based link 228 corresponds to link 208. A code 226 replaces the blog entry 210. In one embodiment of code 226 for a blog entry, code 226 includes the special symbol, the table indicator, table id, and an addition entry number “E:7”.

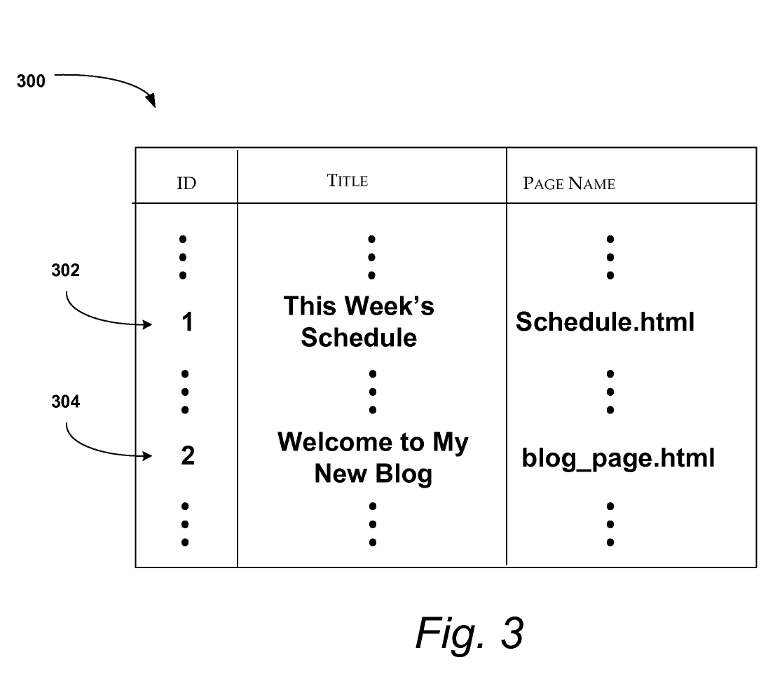

FIG. 3 is an example of a mapping table created by the reference-based link module during processing of a web document. The reference-based link module may use any number of tables to store the correlation between the link and reference-based link. For example, there may be a separate table for albums, folders, blogs, images, and the like. As one skilled in the art will appreciate, the implementation of the mapping tables may vary without departing from the scope of the present invention. FIG. 3 illustrates one table 300 having entries for both the mark-up language page and blog entry for the example shown in FIG. 2. Thus, referenced-based link 222 appears as entry 302 in table 300. The id “1” is located in the id column of table 300. The page “Schedule.html” is located in the page name column of table 300. Referenced-based link 226 in FIG. 2 appears as entry 304 in the table 300. The id “2” is located in the id column of table 300 and the page “blog_page.html” is located in the page name column of table 300.

FIG. 4 is an example of a history table 400 that may be used in implementations of the reference-based link system. History table 400 includes three columns 402-404. Column 402 is a date column. Column 404 is an old name for the link. Column 406 is a new name for the link. Entries 410-414 illustrate the changes to a resource name “MyChair.Htm”. Entry 410 illustrates that “MyChair.Htm” changed to “OldChair.Htm” on Jan. 19, 2007. Entry 412 illustrates that “OldChair.Htm” changed to “Chair.Htm” on May 20, 2008. Entry 414 illustrates that “Chair.Htm” changed to “Chairs.Htm” on Jul. 16, 2008. The resource name can include changes in the path name and/or file name. The reference-based link module uses the history table 400 to search for a resource that currently does not exist. For example, if a web server requested a page that included “MyChair.Htm”, the reference-based link module would determine that “MyChair.Htm” does not exist currently on the web site. However, by accessing history table 400, the reference-based link module determines that “MyChair.Htm” is actually “Chairs.Htm” now and can transmit that resource to the web server. If it is not possible to determine a valid link for the requested link using the history, a pre-determined page may be displayed for links to web pages.

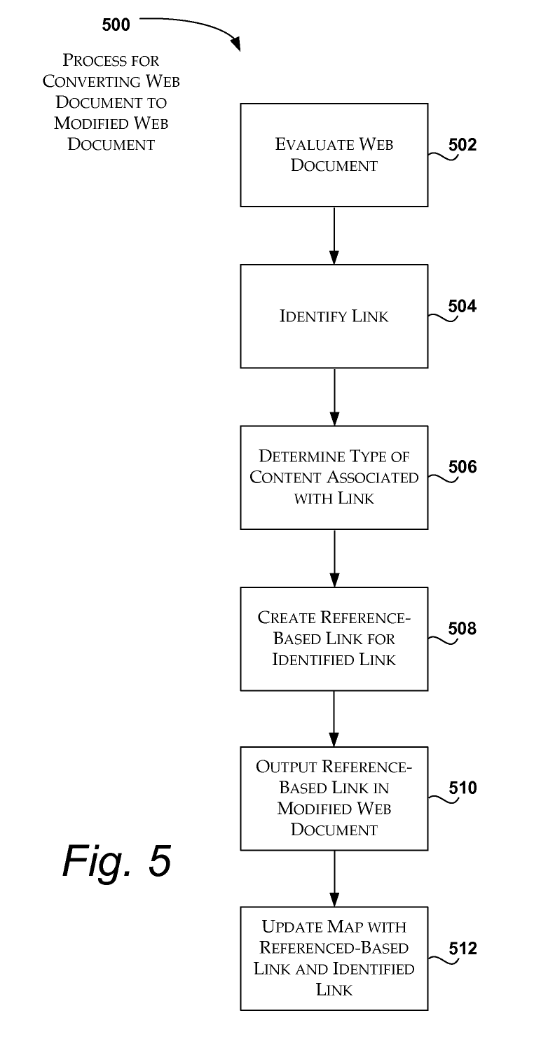

FIG. 5 is a flow diagram illustrating a process for converting links in a web document to reference-based links in an associated modified web document. At block 502, a web document is evaluated. As discussed earlier, the web document may be automatically converted upon a predetermined event, such as a file save, elapse of a time period, or the like, or the web document may be converted upon a user request.

At block 504, a link is identified within the web document. Process 500 can parse through the entire web document to identify any number of links. The links are identified using conventional techniques.

At block 506, a determination is made as to what type of content is associated with the link. In one embodiment, different types of content use different maps for mapping the link to the reference-based link. In another embodiment, one map may be used for all types of content.

At block 508, a reference-based link is created for the identified link. As shown in FIG. 3 and discussed above, the reference-based link may use a specific character, such as brackets “{” to identify a reference-based link in the modified web document. Any special character or set of characters may be used to identify the text as a reference-based link. It is desirable to use characters that are typically uncommon in conventional web documents.

At block 510, the reference-based link is output in the modified web document. The modified web document contains the formatting and structure of the original web document, and includes the reference-based links in place of the conventional links.

At block 512, a map associated with the type of content for the reference-based link is updated. As shown in FIG. 3 and described above, the map correlates the identified link with the reference-based link.

One skilled in the art will appreciate that the implementation of the blocks is a matter of choice dependent on the performance requirements of the computing device implementing the embodiment. In addition, the order of the blocks listed need not be the order that the blocks are executed. For example, blocks 510 and 512 may be interchanged without departing from the scope of the present invention. In addition, some blocks may be omitted, such as block 506.

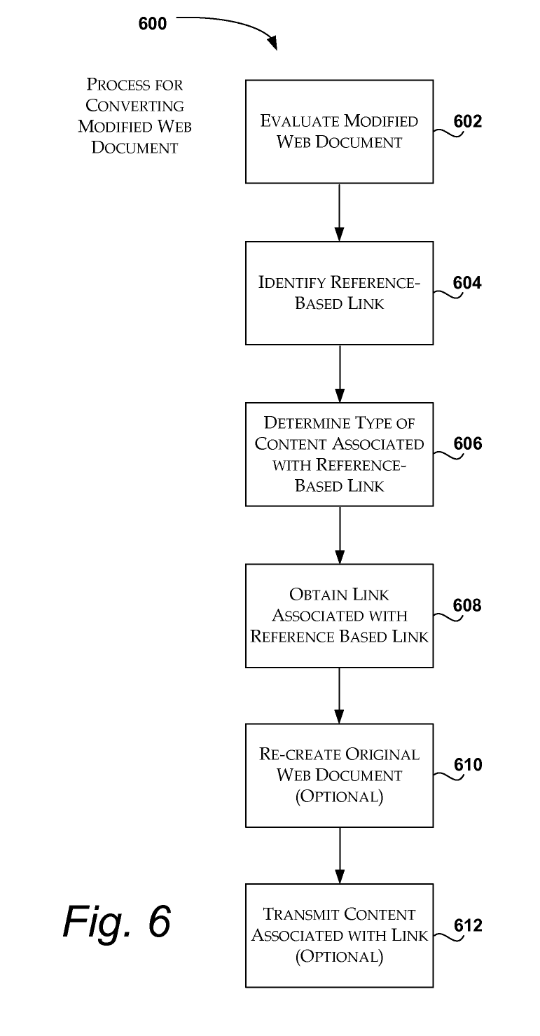

FIG. 6 is a flow diagram illustrating a process for converting reference-based links to conventional links. At block 602, a modified web document is input for processing. At block 604, a reference-based link is identified. The reference-based link may be identified by a unique character(s) within the modified web document. At block 606, the type of content associated with the reference base link is determined. At block 608, the link associated with the reference-based link is obtained from an associated map. At block 610, the link may be optionally stored in a new original web document. For example, if the reference-based link module is not operating on the fly and being responsive to a web page request, the reference-based link module may convert the modified web document and save the re-created original web document for later use. However, if the reference-based link module is operating dynamically and being responsive to a web page request, the content associated with the link may be transmitted to a browser. Thus, the reference-based link module may operate as a module within the browser to re-convert modified web documents.

Again, one skilled in the art will appreciate that the implementation of the blocks is a matter of choice dependent on the performance requirements of the computing device implementing the embodiment.

FIG. 7 is a functional block diagram of an exemplary computing device that may be used to implement one or more embodiments of the reference-based link system shown in FIG. 1. The exemplary computing device 700 may be a mobile device, a laptop device, a desktop device, a server, and other devices. The reference-based link module may execute on one or more computing devices as computer-executable instructions. The web authoring tool may execute on the same computing device(s) as the reference-based link module or on different computing devices. The computing device 700, in one basic configuration, includes at least a processing unit 702 and memory 704. Depending on the exact configuration and type of computing device, memory 704 may be volatile (such as RAM), non-volatile (such as ROM, flash memory, etc.), or some combination of the two. This basic configuration is illustrated in FIG. 7 by dashed line 706.

Additionally, device 700 may also have other features and functionality. For example, device 700 may also include additional storage (removable and/or non-removable) including, but not limited to, magnetic or optical disks or tape. Such additional storage is illustrated in FIG. 7 by removable storage 708 and non-removable storage 710. Computer storage media includes volatile and nonvolatile, removable and non-removable media implemented in any method or technology for storage of information such as computer readable instructions, data structures, program modules or other data. Memory 704, removable storage 708, and non-removable storage 710 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 700. Any such computer storage media may be part of device 700.

Computing device 700 includes one or more communication connections 714 that allow computing device 700 to communicate with one or more computers and/or applications 713. Device 700 may also have input device(s) 712 such as keyboard, mouse, pen, voice input device, touch input device, etc. Output device(s) 711 such as a monitor, speakers, printer, PDA, mobile phone, and other types of digital display devices may also be included. These devices are well known in the art and need not be discussed at length here.

It is important to note that various embodiments are described fully above with reference to the accompanying drawings, which form a part hereof, and which show specific implementations for practicing various embodiments. However, other embodiments may be implemented in many different forms and should not be construed as limited to the embodiments set forth herein; rather, these embodiments are provided so that this disclosure will be thorough and complete. Embodiments may be practiced as methods, systems, or devices. Accordingly, embodiments may take the form of a hardware implementation, an entirely software implementation, or an implementation combining software and hardware aspects. The detailed description above, therefore, is not to be taken in a limiting sense.

In addition, in various embodiments, the logical operations may be implemented (1) as a sequence of computer implemented steps running on a computing device and/or (2) as interconnected machine modules (i.e., components) within the computing device. The implementation is a matter of choice dependent on the performance requirements of the computing device implementing the embodiment. Accordingly, the logical operations making up the embodiments described herein are referred to alternatively as operations, steps, or modules.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer storage media having computer-executable instructions for creating a modified web document from a web document, the computer-executable instructions, when executed, perform a method comprising:
identifying a local link within the web document, the local link referencing a resource served by a web service;
creating a reference-based link for the local link, the reference-based link remaining constant even if the corresponding local link changes; and
creating a modified web document by replacing the local link within the web document with the reference-based link.

2. The computer storage media recited in claim 1, wherein creating a reference-based link for the local link comprises assigning a code to the local link.

3. The computer storage media recited in claim 2, wherein the code comprises a symbol to indicate a start for the reference-based link and an identifier for locating the local link in a map that correlates the local link with the reference-based link.

4. The computer storage media recited in claim 1, wherein the local link comprises a uniform resource locator (URL) pointing to at least one resource out of a set comprising a web page, blog entry, image file, audio file, video file.

5. The computer storage media recited in claim 1, further comprising storing a mapping between the local link and the reference-based link, the mapping correlates the local link with the reference-based link.

6. The computer storage media recited in claim 1, further comprising looking up the local link in a mapping history to determine a current valid link for a dead link if the local link comprises the dead link.

7. The computer storage media recited in claim 6, wherein the mapping history stores changes to the resource associated with the link.

8. A computer-implemented method for managing a web site, comprising:
evaluating a web document to identify a local link;
creating a reference-based link for the local link;
replacing the local link within the web document with the reference-based link; and
storing correlation information for the reference-based link and the local link.

9. The computer-implemented method recited in claim 8, further comprising monitoring access to files on the web site and storing a history of name changes made to the files, wherein the local link corresponds to one of the files in the history.

10. The computer-implemented method recited in claim 9, wherein evaluating the web document includes identifying the local link as a dead link and obtaining a current link for the dead link from the history.

11. The computer-implemented method recited in claim 10, wherein the mapping history stores changes to the resource associated with the link.

12. The computer-implemented method recited in claim 8, wherein the local link comprises a uniform resource locator (URL) pointing to at least one resource out of a set comprising a web page, blog entry, image file, audio file, video file.

13. The computer-implemented method recited in claim 12, wherein the reference-based link comprises an identifier to the correlation information and another identifier to reference the local link within the correlation information.

14. The computer-implemented method recited in claim 8, further comprising storing a modified web document that has the local link replaced with the reference-based link in the web document.

15. A computer-implemented method for retrieving resources from a web site, comprising:
receiving a request for a web document associated with the web site;
identifying a modified web document for the web document, the modified web document containing a reference-based link for a link in the web document;
obtaining a resource based on the reference-based link; and
transmitting the resource to a web server to fulfill the request.

16. The computer-implemented method recited in claim 15, wherein the reference-based link remains constant even if a corresponding resource changes location.

17. The computer-implemented method recited in claim 15, wherein the link comprises a uniform resource locator (URL) pointing to at least one resource out of a set comprising a web page, blog entry, image file, audio file, video file.

18. The computer-implemented method recited in claim 15, wherein the reference-based link is transparent to a user.

19. The computer-implemented method recited in claim 15, wherein the link is associated with a resource served by a web service maintaining the website.

20. The computer-implemented method recited in claim 15, wherein obtaining a resource comprises identifying the link as a dead link, obtaining a current link for the dead link from the history, and obtaining the resource based on the current link.
